(19) United States
(12) Patent Application Publication
(10) Pub. No.: US 2003/0122964 A1
(43) Pub. Date: Jul. 3, 2003

(54) Synchronization network, system and method for synchronizing audio

(75) Inventor: Hiroshi Hara, San Diego, CA (US)

Correspondence Address: Intellectual Property Department, Sony Electronics Inc., 16450 West Bernardo Drive, MZ 7190, San Diego, CA, 92127-1898, US

(73) Assignee: Sony Electronics Inc.

(21) Appl. No.: 10/038,315

(22) Filed: Jan. 2, 2002

(51) Int. Cl. H04N 7/16; H04N 9/475

(52) U.S. Cl. 348/515; 725/135; 348/512

(57) ABSTRACT

A method of synchronization for a network and a system is provided, wherein a first device is utilized to decode an audio signal and a second device is utilized to decode a video signal. The method of synchronization includes determining an output difference. In one embodiment, the output difference is calculated by determining a first processing speed of a first decoder in the first device and determining a second processing speed of a second decoder in the second device. In another embodiment, the method of synchronization further includes utilizing the difference between the first processing speed and the second processing speed to synchronize the audio signal with the video signal. In a further embodiment, a decoded audio signal is stored in a first buffer in the first device. In yet another embodiment, the method of synchronization further includes utilizing the difference between the first processing speed, the second processing speed and a distance between the first device and the second device to synchronize an output of the audio signal stored in the first buffer with the video signal.

### CROSS REFERENCE TO RELATED DOCUMENTS

This application incorporates herein by reference patent application Ser. No. ______ (Sony IPD 50R4871), filed concurrently herewith, by Hiroshi Hara and Tohru Doumuki, entitled AN AUDIO/VIDEO NETWORK, SYSTEM AND METHOD FOR PROVIDING AUDIO.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### FIELD OF THE INVENTION

This invention relates generally to the field of home audio/video network systems. More particularly, this invention relates to providing synchronization to a network and a system.

### BACKGROUND OF THE INVENTION

A typical home audio/video (AV) equipment set up includes a number of components and peripheral devices, such as, for example, an AV amplifier, a DVD/CD player, speakers, a television, a VCR, and the like. Each of these components are connected to each other via a set of wires, with one component usually being central to a home AV system. This is usually the AV amplifier, or a receiver. The AV amplifier has a number of specific inputs for coupling the other components and peripheral devices.

The coupling of the other components and peripheral devices is typically accomplished through the use of connectors, with the AV amplifier having a corresponding number of control buttons or control switches which provide a limited degree of controllability and interoperability for the coupled components and peripheral devices. A user controls the home audiovisual system by manipulating the buttons or switches on the front of the AV amplifier, or alternatively, manipulating buttons on a hand-held remote control unit.

This conventional home AV system paradigm has become quite popular. However, the emergence of networking and interface technology (e.g., IEEE 1394 serial communication bus and the wide spread adoption of digital systems) promises a whole new paradigm of home AV peripheral devices and services. The latest and most popular consumer AV peripheral devices (e,g., digital or High Definition TV, DVD players, digital camcorders, mini-disk players, and the like) are based upon digital technology. These AV peripheral devices include sophisticated embedded computer systems.

These AV peripheral devices deliver greatly enhanced functionality and features, as their embedded systems execute elaborate software-based algorithms and are highly configurable, depending upon the desires and taste of the user. The digital nature of the devices allow them to be readily networked into a coherent digital home AV network. Several standards have emerged which define the interfaces and connections for such networks. Currently, the most popular transport technology for digital home AV networks is IEEE 1394. The IEEE 1394 serial bus, often referred to as FireWire™ or i.LINK™, provides a high bandwidth communications protocol upon which an open, intelligent, self-configuring, extensible home AV network architecture can be implemented.

However, while the nature and capabilities of home AV systems have changed dramatically with the advent of i.LINK™ and AV peripheral devices, the ability to provide controllability and interoperability for the coupled components and peripheral devices has decreased in certain regards. For example, when an audio signal is decoded in a first device and a video signal is decoded in a second device in the home AV network and AV system, a “lip” synchronization problem will occur.

### SUMMARY OF THE INVENTION

In view of the foregoing, a method of synchronization for a network and a system is provided.

In particular and in one embodiment, when a first device is utilized to decode an audio signal that comes on a transport stream with a standard definition signal or a high definition signal, and a high definition video signal is passed through a digital connection, for example an i.LINK™, to a second device, then the method of synchronization includes determining a first processing speed of a first decoder in the first device and determining a second processing speed of a second decoder in the second device. In one embodiment, the method of synchronization further includes utilizing the difference between the first processing speed and the second processing speed to synchronize the audio signal with the video signal. In a further embodiment, a decoded audio signal is stored in a first buffer in the first device, then the method of synchronization further includes utilizing the difference between the first processing speed and the second processing speed to synchronize an output of the audio signal stored in the first buffer with the video signal.

These and other features and advantages of the invention will be understood upon the consideration of the following detailed description of the invention and accompanying drawing. The features of the invention believed to be novel are set forth with particularity in the appended claims. The invention itself however, both as to organization and method of operation, together with further objects and advantages thereof, may be best understood by reference to the following description taken in conjunction with the accompanying drawing.

### BRIEF DESCRIPTION OF THE DRAWING

The following detailed description, given by way of example, and not intended to limit the present invention solely thereto, will best be understood in conjunction with the accompanying drawings in which:

FIG. 1 is a flow diagram of one embodiment of a method of synchronization for a network and a system.

### DETAILED DESCRIPTION OF THE INVENTION

While the present invention has been particularly shown and described with reference to an embodiment(s), it will be understood that various changes and modifications may be made without departing from the spirit and scope of this invention. It is intended that the appended claims be interpreted to cover the embodiments described herein and all equivalents thereto.

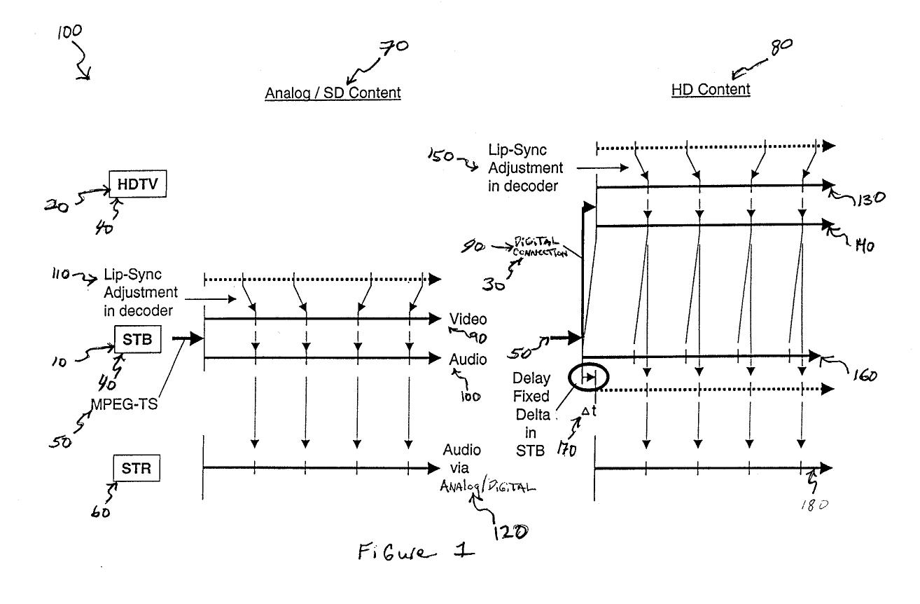

Turning now to FIG. 1, illustrated is one embodiment of a method of synchronization 100 for a network (not shown) and a system (not shown). In one embodiment, a first device, for example a set top box (STB), 10 and a second device, for example a high definition television (HDTV) 20 are in electrical communication through digital connection 30 and form an audio/video (AV) network 40. Analog video signals and a Moving Picture Experts Group transport stream (MPEG-TS) 50 is provided to AV network 40 and forwarded to an AV amplifier (STR) 60 after processing. MPEG-TS 50 carries an analog/standard definition content 70, or a high definition content 80.

When analog/standard definition content 70 is carried by analog video signals and MPEG-TS 50, an analog/standard definition content video signal 90 and an audio signal 100 are processed by STB 10 and decoded in a first decoder (not shown). STB 10 includes a first buffer (not shown) that is configured to store a decoded audio signal. The first decoder is in electrical communication with the first buffer. Because standard definition content video signal 90 and audio signal 100 are both decoded in STB 10, a lip-sync adjustment 10 occurs in the first decoder. In the case of the standard definition signal, first device 10 decodes the standard definition signal and then forwards the received and decoded signal to AV amplifier 60 through analog (not shown) or digital (not shown) connectors 120. The decoded audio signal is then forwarded to speakers (not shown) while a decoded video signal is forwarded to the second device 20, also through analog or digital connectors 120.

In the instance when high definition content 80 is carried by MPEG-TS 50, a high definition content video signal 130 and a first audio signal 140 are both decoded in HDTV 20 by a second decoder (not shown). Because high definition content video signal 130 and first audio signal 140 are both decoded in second device 20, a lip-sync adjustment 150 occurs in the second decoder. However, a second audio signal 160 is processed in first device 10 by the first decoder and a fixed delay or difference, ΔT 170 results when comparing a difference 170 between a first processing speed of high definition content video signal 130 and first audio signal 140 with a second processing speed of second audio signal 160. ΔT 170 is not only caused by the difference between the first decoder and the second decoder but also caused by the distance between the two devices and their respective decoders, as well as the number of sub-devices included in a device.

A method for synchronizing audio in AV network 40 includes synchronizing second audio signal 160 from first device 10 with video signal 130 from second device 20. Synchronizing audio signal 160 with video signal 130 in AV network 40 includes determining the first processing speed of the first decoder in the first device, determining the second processing speed of the second decoder in the second device, determining the ΔT caused by the distance between the two devices, and utilizing the first processing speed, the second processing speed, and the ΔT to synchronize audio signal 160 from first device 10 with video signal 130 from second device 20. In one embodiment, the method includes storing the decoded audio signal in the first buffer in first device 10. In another embodiment, second device 20 includes a second buffer in electrical communication with the second decoder and the method further includes storing a decoded video signal in the second buffer in second device 20. In a further embodiment, the method for providing audio in AV network 40 further includes utilizing ΔT 170 and the first processing speed and the second processing speed to synchronize an output of the first buffer with an output of the second buffer.

In yet another embodiment, AV network 40 may be utilized as a synchronization network which includes first device 10 and second device 20. First device 10 includes an audio decoder, and second device 20 includes a video decoder. First device 10 is in electrical communication with second device 20. First device 10 further includes the first buffer, which is configured to store the decoded audio signal, while second device 20 further includes the second buffer, which is configured to store the decoded video signal. In one embodiment, the synchronization network further includes at least one synchronization circuit (not shown) in electrical communication with the first buffer and the second buffer. A synchronized audio signal 180 is then forwarded to AV amplifier 60 through analog or digital connectors 120 and then forwarded to speakers while the decoded video signal is displayed on HDTV 20.

Various other modifications and alterations in the structure and method of operation of this invention will be apparent to those skilled in the art, without departing from the scope and spirit of the invention. Although the invention has been described in connection with specified preferred embodiments, it should be understood that the invention, as claimed, should not be unduly limited to such specific embodiments. It is intended that the following claims describe the scope of the present invention and that the structures and methods within the scope of these claims and their equivalents be covered thereby.

What is claimed is:

1. A method for synchronizing audio in an audio/video network, said method comprises synchronizing an audio signal generated from a first device with a video signal generated from a second device in the audio/video network.

2. A method for synchronizing audio in an audio/video network as recited in claim 1, wherein synchronizing an audio signal generated from a first device with a video signal generated from a second device in the audio/video network comprises:
determining a first processing speed of a first decoder in said first device;
determining a second processing speed of a second decoder in said second device; and
utilizing said first processing speed and said second processing speed to synchronize said audio signal from said first device with said video signal from said second device.

3. A method for synchronizing audio in an audio/video network as recited in claim 2, wherein utilizing said first processing speed and said second processing speed to synchronize said audio signal generated from said first device with said video signal generated from said second device comprises determining a difference between said first processing speed and said second processing speed.

4. A method for synchronizing audio in an audio/video network as recited in claim 3, wherein said method further comprises storing a decoded audio signal in a first buffer in said first device.

5. A method for synchronizing audio in an audio/video network as recited in claim 4, wherein said first device selected from the group consisting of a set top box, an audio/video receiver, and any equivalent computing device(s).

6. A method for synchronizing audio in an audio/video network as recited in claim 4, wherein said method further comprises storing a decoded video signal in a second buffer in said second device.

7. A method for providing audio in an audio/video network as recited in claim 3, wherein said method further comprises utilizing said difference between said first processing speed and said second processing speed to synchronize an output of a first buffer with an output of a second buffer.

8. A synchronization network comprising:
a first device, including an audio decoder; and
a second device, including a video decoder, said first device being in electrical communication with said second device.

9. A synchronization network as recited in claim 8, wherein said first device further includes a first buffer configured to store a decoded audio signal, said first buffer in electrical communication with said second device.

10. A synchronization network as recited in claim 9, wherein said second device further includes a second buffer configured to store a decoded video signal, said second buffer in electrical communication with said first device.

11. A synchronization network as recited in claim 10, further comprising at least one synchronization circuit in electrical communication with said first buffer and said second buffer.

12. A system for synchronizing audio in an audio/video network, said system comprises:
a first device, including a standard signal decoder;
a second device, including a high definition signal decoder, said first device being in electrical communication with said second device; and
at least one peripheral device in electrical communication with said first device and said second device.

13. A system for synchronizing audio in an audio/video network as recited in claim 12, wherein said first device further includes a first buffer in electrical communication with said standard signal decoder, said first buffer in electrical communication with said second device, said first buffer further in electrical communication with said peripheral device.

14. A system for synchronizing audio in an audio/video network as recited in claim 13, wherein said second device further includes a second buffer in electrical communication with said high definition signal decoder, said second buffer in electrical communication with said first device, said first buffer and said second buffer further in electrical communication with said peripheral device.

15. A system for synchronizing audio in an audio/video network as recited in claim 14, wherein said peripheral device is selected from the group consisting of an audio/video amplifier device, a VCR, a DVD player/recorder, a digital entertainment device, and any like computing device(s).

16. A system for synchronizing audio in an audio/video network as recited in claim 14, wherein said peripheral device includes a synchronization circuit in electrical communication with said first buffer and said second buffer.
